(19) United States
(12) Patent Application Publication
(10) Pub. No.: US 2025/0353595 A1
(43) Pub. Date: Nov. 20, 2025

(54) SEAT MOUNTED TO STRUCTURAL COLUMN AND METHODS THEREOF

(71) Applicant: Supernal, LLC, Washington, DC (US)

(72) Inventors: Alexander POZZI, Carlsbad, CA (US); Christopher HA, Irvine, CA (US)

(73) Assignee: Supernal, LLC, Washington, DC (US)

(21) Appl. No.: 18/866,222

(22) PCT Filed: Jul. 11, 2023
(86) PCT No.: PCT/US2023/069980

§ 371 Date: Nov. 15, 2024

Related U.S. Application Data
(60) Provisional application No. 63/368,337, filed on Jul. 13, 2022.

(51) Int. Cl. B64D 11/06; B64D 11/00; B64D 45/00

(52) U.S. Cl. CPC B64D 11/06; B64D 11/0015; B64D 11/0689; B64D 45/00

(57) ABSTRACT

Systems and methods for a vehicle containing a structural column are disclosed. The vehicle includes: a structural column positioned between a first and second interior surface of the vehicle. The vehicle may further include a seating assembly attached to a first surface of the structural column, wherein the seating assembly comprises a seating surface and a seat back. In addition, the structural column may be configured to redistribute a force load to at least one other structural component in the vehicle. Other aspects are described and claimed.

### CROSS REFERENCE TO RELATED APPLICATIONS

This application claims priority to U.S. Provisional Application No. 63/368,337 filed Jul. 13, 2022, which is incorporated by reference herein in its entirety.

### FIELD OF THE DISCLOSURE

The present disclosure relates generally to structural components of a vehicle, and more specifically, to systems and methods that integrate a structural column within an aircraft cabin to improve operational efficiency and passenger experience.

### BACKGROUND

Air travel remains a popular form of transportation among individuals. In order to effectively handle the volume of passengers that fly each day, aircraft must be designed to facilitate efficient boarding and deplaning processes. Currently, the presence of substantial partitions in the aircraft fuselage (e.g., those that separate the pilot(s) from the passengers within the cabin) may consume valuable interior space and may hamper the movement through the aircraft of passengers and crew. Additionally, these partitions are generally not load-bearing structures, thereby requiring other components of the aircraft (e.g., the airframe, etc.) to be designed thicker to handle load-bearing responsibilities, which may correspondingly increase the aircraft weight and consequently increase the rate of fuel consumption.

The present disclosure is accordingly directed to a structural column located within an interior of a vehicle (e.g., an aircraft such as an electric vertical take-off and landing (eVTOL) vehicle) that may act as a central load-bearing structure and that also may be configured to distribute impact loads to other structural supports of the vehicle. The structural column may further be configured to support a seat of a vehicle operator and may be designed to improve passenger mobility within the cabin. The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed for providing a vertical structural column into a vehicle that is configured to support an operator seat.

In one aspect, a vehicle is disclosed. The vehicle includes: a structural column positioned between a first and second interior surface of the vehicle. The vehicle may further include a seating assembly attached to a first surface of the structural column, wherein the seating assembly comprises a seating surface and a seat back. In addition, the structural column may be configured to redistribute a force load to at least one other structural component in the vehicle.

In another aspect, an aircraft is disclosed. The aircraft includes: a load-bearing element attached to a first interior surface at a first end and attached to a second interior surface at a second end. The aircraft further includes a pilot seat that is coupled to the load-bearing element and is oriented in a first direction. In addition, the load-bearing element is configured to provide structural support against a force load experienced during operation of the aircraft.

In yet another aspect, a method of redistributing a force load experienced by a vehicle is disclosed. The method includes: receiving, at a support column positioned within a cabin of the vehicle, the force load, wherein the support column is positioned between a first and second interior surface of the vehicle; and redistributing, via connection of the support column with an additional support element, the force load to the additional support element.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate the disclosed embodiments, and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure. In the drawings:

FIG. 1 illustrates an exemplary structural column in a vehicle, according to one or more aspects of the present disclosure.

FIG. 2 illustrates another view of the exemplary structural column in the vehicle, according to one or more aspects of the present disclosure.

FIG. 3 illustrates a side view of a vehicle containing an exemplary structural column, according to one or more aspects of the present disclosure.

FIG. 4 illustrates a cross section of the vehicle illustrated in FIG. 3, according to one or more aspects of the present disclosure.

### DESCRIPTION OF EXEMPLARY EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

Embodiments of the present disclosure may be incorporated into an aircraft. As used herein, “aircraft” may refer to an aerial, floating, soaring, hovering, airborne, aeronautical aircraft, airplane, plane, spacecraft, vessel, or virtually any other vehicle moving, or capable of moving, through air. Some non-limiting examples may include a helicopter, an airship, a hot air balloon, a vertical take-off craft (e.g., an electric vertical take-off and landing (eVTOL)), an unmanned aerial vehicle, or a drone.

The number of commercial flights involved in modern air transportation has greatly increased over time. With this surge comes a need to address the challenges associated with efficient passenger boarding and deplaning. More particularly, many aircraft contain various types of interior partitions, or “bulkheads,” that may span a horizontal length of the fuselage and are generally utilized to separate one area of the fuselage from another (e.g., the pilot cockpit from the passenger cabin). These partitions occupy valuable interior space and may impede the flow of both passenger and crew movement. Furthermore, conventional partitions do not serve any type of load-bearing or structural purpose, thereby requiring additional structure (e.g., beams, braces, frames, partitions, etc.) to be implemented in the aircraft to handle the higher loads and impact forces that may be experienced during flight.

The addition of supplementary components comes with certain drawbacks. Primarily, the weight of the aircraft will likely be increased, which may lead to faster fuel consumption, higher operating costs, and ultimately higher ticket prices for passengers. Furthermore, adding more components to an already crowded cabin may further limit the freedom of passenger movement. Moreover, since the additional structure is not directly integrated within the passenger compartment, it may not provide optimal load conditions for certain seating arrangements, which may impact passenger comfort and potentially compromise the overall efficiency of the aircraft.

To address the above-mentioned issues, the present disclosure provides an innovative structural column (“column”) that may be situated within a vehicle. This column may be a load-bearing vertical column that may be strategically positioned within an aircraft cabin to act as a pivotal support element for the aircraft while simultaneously serving as the anchor point for a vehicle operator's seat. The utilization of this column may replace or reduce the reliance on the foregoing additional support features, which may correspondingly reduce the weight of the aircraft and ultimately improves its fuel efficiency. Another benefit of this column is that it may provide a more spacious cabin interior, thereby allowing passengers to move with greater freedom during boarding, deplaning, and potentially during flight. Furthermore, by mounting the pilot's seat onto the structural column, easy access to both the seat and operator controls is ensured, thereby streamlining pilot operations and enhancing flight safety.

The subject matter of the present disclosure will now be described more fully hereinafter with reference to the accompanying drawings, which form a part hereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” or “in some embodiments,” or “in one aspect” or “in some aspects” as used herein does not necessarily refer to the same embodiment or aspect, and the phrase “in another embodiment” or “in another aspect” as used herein does not necessarily refer to a different embodiment or aspect. It is intended, for example, that claimed subject matter include combinations of exemplary embodiments in whole or in part.

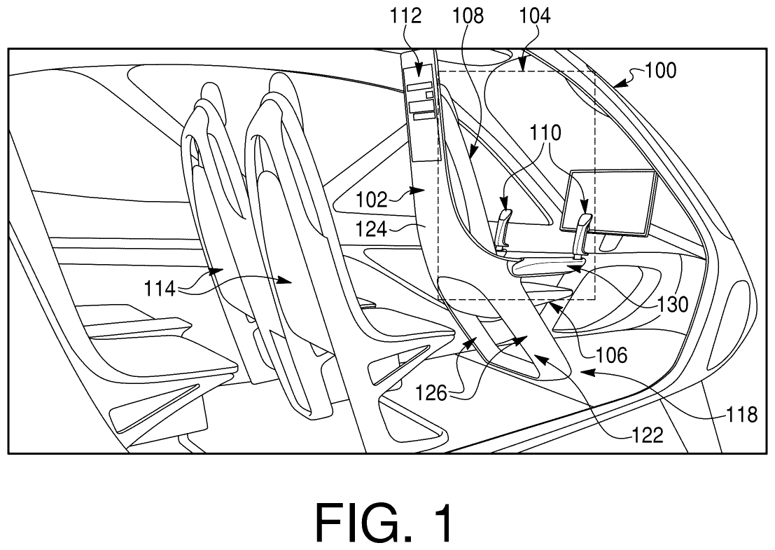

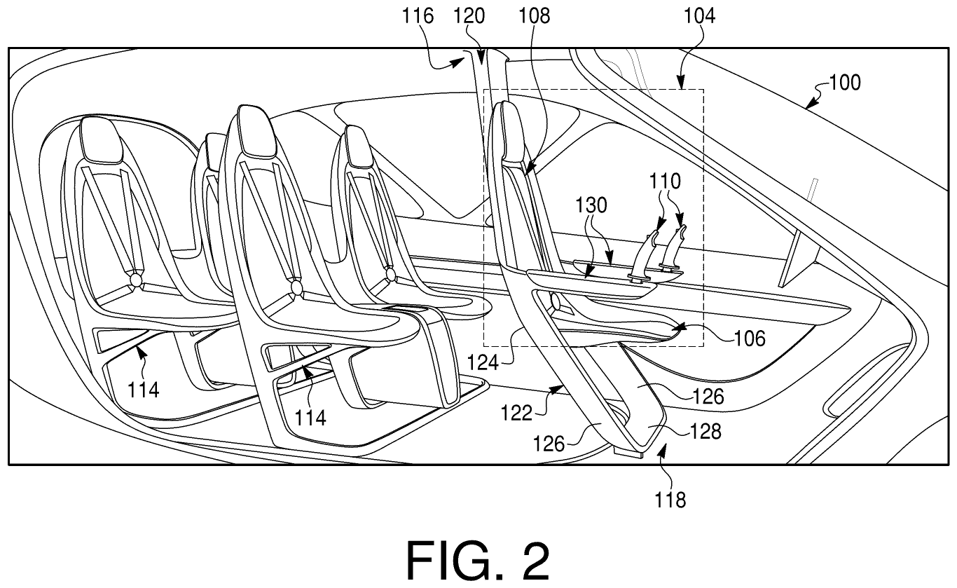

Referring collectively to FIGS. 1 and 2, an interior cabin of vehicle 100 is illustrated, according to exemplary aspects of the present disclosure. The interior cabin may contain column 102 upon which operator seat assembly 104 may be mounted on a first surface (e.g., a surface of column 102 oriented toward the front of vehicle 100). Operator seat assembly 104 may contain seating surface 106 and seat back 108 that may enable a vehicle operator to comfortably sit in vehicle 100 and control its operation by interacting with one or more control devices 110. A second surface of column 102 (e.g., a surface oriented toward a rear of vehicle 100), may contain display 112 mounted to a region of the second surface. Display 110 may be configured to present various types of information and content to the vehicle passengers, who may be seated in one or more passenger seats 114 positioned behind column 102.

In an aspect, column 102 may be disposed between top interior surface 116 and bottom interior surface 118 of vehicle 100. Top interior surface 116 may correspond to a ceiling of the vehicle cabin whereas bottom interior surface 118 may correspond to a floor of the vehicle cabin. Column 102 may be connected to top interior surface 116 by first end 120 of column 102 and bottom interior surface 118 by second end 122 of column 102. Additional details regarding the connection of column 102 to vehicle 100 are further provided herein. In an aspect, column 102 may have a single and consistent shape throughout its length. For example, column 102 may be substantially cylinder-shaped, rectangular-shaped, etc. Alternatively, in another aspect, column 102 may adopt varying shapes along its length. For instance, a top third portion of column 102 may be cylindrically-shaped, a middle third portion may be rectangular-shaped, and a bottom third portion may again be cylindrically-shaped. The utilization of such a multi-shaped column may maximize weight distribution along the length of column 102. Additionally, a multi-shaped column may provide other benefits to passengers, such as increased visibility (e.g., around column 102 and to front portions of vehicle 100) and/or additional storage, as further described herein.

In an aspect, an entirety of column 102 may be substantially straight (e.g., between oppositely-positioned top and bottom interior surfaces 116, 118). Alternatively, in another aspect, column 102 may contain at least one bend or curve along its length. For instance, FIGS. 1 and 2 illustrate that column 102 is bent at approximately midpoint 124. In this configuration, top interior surface 116 that first end 120 of column 102 is connected to is no longer positioned directly opposite second end 122 and bottom interior surface 118. The angled nature of second end 122 may create an inherent storage space for various objects (e.g., passenger feet and/or legs, personal items such as backpacks or laptop bags, clothing items such as coats, etc.). Furthermore, in some aspects, second end 122 of column 102 may be shaped the same way as first end 120. For instance, each of first and second ends 120, 122 may terminate in a substantially cylindrical portion. Alternatively, in another aspect, first end 120 may be shaped differently than second end 122. For instance, first end 120 of column 102 illustrated in FIGS. 1 and 2 is a single element that is substantially rectangular-shaped whereas second end 122 of column 102 contains two opposite-facing segments 126 that are connected together at bottom interior surface 118 by horizontal member 128.

In an aspect, column 102 may be composed of one or more materials that are selectively chosen to both minimize column weight and simultaneously maximize the impact load that column 102 may absorb before compressing. For instance, column 102 may be composed of a material such as aluminum, plastic, a composite, and the like. When column 102 experiences loads greater than a predetermined threshold, deformation of portions of column 102 may occur to provide energy attenuation to vehicle 100. In an aspect, a material such as aluminum foam may be contained within a central hollow (not illustrated) of column 102. This type of foam may be designed to enable its shape and structure to be compressed in the event of a particular impact event (e.g., a crash). In another aspect, column 102 may contain other characteristics or structural members that are designed to absorb energy when loads exceed a predetermined threshold force. For instance, an interior portion of column 102 may be contain a partially hollow material pattern (e.g., a honeycomb pattern, a checkered lattice, etc.) that is designed to crush or deform in response to experiencing a predetermined threshold force. In one aspect, substantially the entire length of column 102 may contain such a pattern. Alternatively, in another aspect, only a specific portion of column 102, e.g., a prescribed “crush zone,” may contain the pattern. This portion may delineate the degree to which (i.e., how far) column 102 may be compressed or deformed.

In an aspect, seat assembly 104 may be attached to column 102 by one or more means. For instance, in one aspect, seat assembly 104 may be directly fixed to the first surface of column 102. Alternatively, in another aspect, seat assembly 104 may be mounted to a rod (not illustrated) that runs at least a portion of the vertical length of the first surface of column 102. Through this attachment, a height of seat assembly 104 may be adjusted (e.g., between two or more pre-established height designations, etc.) to accommodate differently-sized vehicle operators. In an aspect, seat assembly 104 may also be designed to stroke down the rod (e.g., by a predetermined amount) in response to certain impact forces experienced by vehicle 100. This stroking event may help to divert certain impact forces (e.g., caused by turbulence, a hard landing, a crash, etc.) away from seat assembly 104 to column 102, thereby minimizing the impact forces that may be experienced by the vehicle operator. In an aspect, seat assembly 104 may further contain arm rests 130 that may allow the vehicle operator to rest their arms during vehicle operation. Each of arm rests 130 may be at least partially extendable (e.g., via utilization of a telescoping or other extendable component) and/or rotatable (e.g., upwards, downwards, etc.).

In an aspect, the vehicle operator may control movement and/or other functional aspects of vehicle 100 by interacting with one or more control devices 110. For instance, FIGS. 1 and 2 depict control devices 110 as two sidesticks, or inceptors, each of which being mounted to a separate arm rest 130 of seat assembly 104. In an aspect, one or both control devices 110 may be hard-wired into the vehicle (e.g., via one or more wires that run from a central vehicle system to control devices 110 via column 102 and seat assembly 104). Alternatively, in another aspect, one or both control devices 110 may communicate with a central vehicle system via a wireless communication modality such as BLUETOOTH, near field communication (NFC), and the like. In the illustrated configuration, the operator may have easy access to control devices 110 and does not need to navigate around a centrally located controller (e.g., one that may be mounted to a console on the floor, as is done in many conventional vehicles), thereby promoting easier ingress to and egress from seat assembly 104. Although depicted in FIGS. 1 and 2 as two inceptors, such a designation is not limiting. More particularly, vehicle 100 may contain more or less control devices 100 of the same or different type. For instance, in one aspect, vehicle 100 may contain a single control device (e.g., a single inceptor). In another aspect, vehicle 100 may contain two control devices, wherein one control device is a hard-wired inceptor and another control device is a wireless controller.

In an aspect, display 112 may be configured to present various types of information to the passengers in vehicle 100. For instance, in one aspect, display 112 may present a variety of different types of flight status information to passengers (e.g., flight speed, height, origin location, destination location, estimated time to destination, elapsed time since departure, alert notifications and/or instructions, other types of informative flight information, etc.). Additionally or alternatively, display 112 may present other types of media content, including entertainment content (e.g., movies, television shows, etc.), advertising content, web-based content, and the like. In an aspect, passengers may interact with display 112 to provide inputs and/or to adjust the displayed content through various means (e.g., via touch input, remote input, voice input, etc.). In an aspect, the vehicle operator may be able to control some or all of the content that is presented on display 112 from seat assembly 104 via utilization of control devices 110. Although illustrated in FIGS. 1 and 2 as a single display, such a designation is not limiting. More particularly, column 102 may contain two or more displays situated about different portions along its length. In this configuration, each display may present substantially the same information or, alternatively, one display may be configured to display a first information type (e.g., flight status information, etc.) whereas another display may be configured to display other types of content (e.g., media content such as movies, TV shows, etc.).

In an aspect, vehicle 100 may contain one or more passenger seats 114 in which passengers may be secured during vehicle operation. The number and arrangement of passenger seats 114 may be dependent upon the size and/or dimensions of vehicle 100. For example, larger aircraft may have multiple rows of two or more seats whereas smaller aircraft may only have a single row of one or two seats. Furthermore, although illustrated in FIGS. 1 and 2 as all facing the same direction (e.g., a forward-facing direction), such a designation is not limiting and different orientations of passenger seats 114 is possible (e.g., the two passenger seats 114 in the front row may be configured to be oriented towards the two passenger seats 114 in the back row). In an aspect, all passenger seats 114 may contain substantially the same dimensions and/or characteristics (e.g., all may be the same size, mounted to vehicle 100 the same way, etc.). Alternatively, in another aspect, some passenger seats 114 may contain different dimensions and/or characteristics than others (e.g., some passenger seats 114 may be larger than others and/or may be configured to swivel or move to accommodate the needs of differently-abled individuals, etc.).

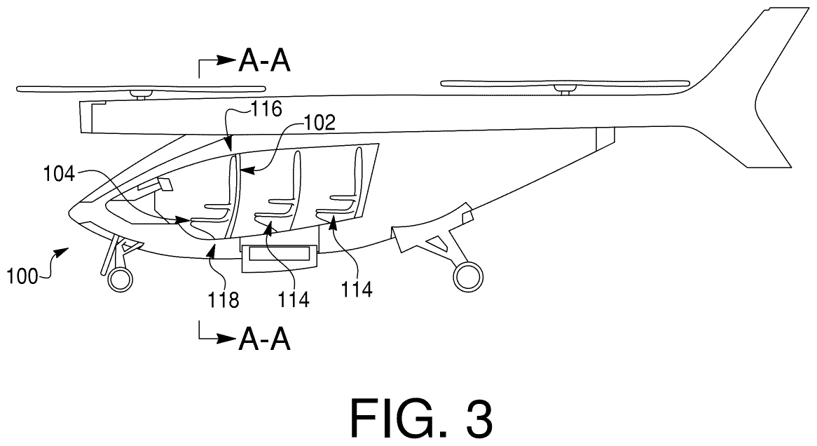

Turning now to FIG. 3, a side view of vehicle 100 is illustrated according to exemplary embodiments of the present disclosure. The side view in FIG. 3 provides an alternative perspective of how column 102 is oriented with respect to seat assembly 104 and passenger seats 114. More particularly, column 102 may be situated between top interior surface 116 and bottom interior surface 118 of vehicle 100. Seat assembly 104 may be positioned on a first surface of column 102 (e.g., a forward-facing surface) and may be oriented toward a front of vehicle 100. Passenger seats 114 may be situated behind column 102 and seat assembly 104 and, as illustrated, are also oriented toward a front of vehicle 100.

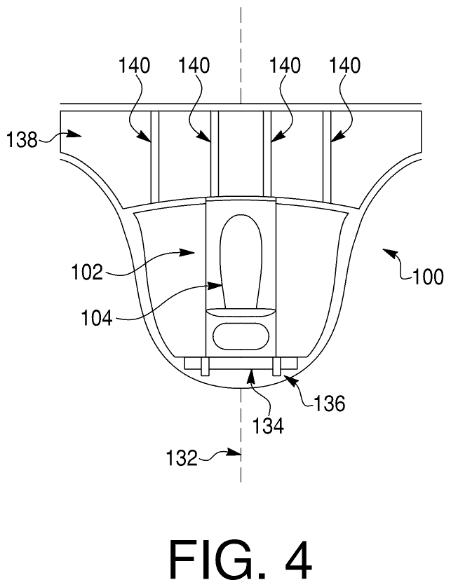

Turning now to FIG. 4, a cross-section view of vehicle 100 along A-A from front to back is illustrated according to exemplary embodiments of the present disclosure. In an aspect, column 102 and seat assembly 104 may be situated along centerline 132 of vehicle 100. Such a placement may ensure that column 102 provides central structural component of vehicle 100. Additionally, this placement may ensure that the vehicle operator is centrally located, which may provide them with an optimal vantage to observe situations occurring in and around vehicle 100. It is important to note, however, that the illustrated placement of column 102 and seat assembly 104 is not limiting and that one or both components may be situated at a different positions within vehicle 100 (e.g., an off-center position).

In an aspect, portions of column 102 may be directly fixed to other vehicle components that provide additional structural support to vehicle 100. For instance, first lateral component 134 and first longitudinal component 136 may provide structural support for a floor of vehicle 100. Specifically, first lateral component 134 may be one of a plurality of lateral components that are aligned in parallel and that span at least a portion of the length of vehicle 100. In an aspect, first lateral component 134 may be, for example, a beam or rib positioned underneath the floor. First longitudinal component 136 may extend perpendicular to first lateral component 136 down a length of vehicle 100. In an aspect, first longitudinal component 136 may be, for example, a keel beam. In an aspect, vehicle 100 may contain one or more keel beams. In an aspect, a portion of second end 122 of column may span through the floor of vehicle 100 (e.g., bottom interior surface 118) and may be attached to one or both of first lateral component 134 and first longitudinal component 136, e.g., by fasteners, screws, mounting brackets, etc. On the opposite side of column 102, a portion of first end 120 may span through a ceiling of vehicle 100 (e.g., top interior surface 120) and may be attached to one or both of second lateral component 138 and second longitudinal component 140. In an aspect, second lateral component 138 may correspond to an airframe housing of vehicle 100 and second longitudinal component 140 may correspond to one or more beams that extend down a length of vehicle 100 within the housing. Collectively, second lateral component 138 and second longitudinal component 140 may provide additional support for the ceiling and wings of vehicle 100.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention. The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A vehicle, comprising:
a structural column positioned between a first and second interior surface of the vehicle; and
a seating assembly attached to a first surface of the structural column, wherein the seating assembly comprises a seating surface and a seat back;
wherein the structural column is configured to redistribute a force load to at least one other structural component in the vehicle.

2. The vehicle of claim 1, wherein the first interior surface is a ceiling of the vehicle and the second interior surface is a floor of the vehicle.

3. The vehicle of claim 1, wherein the structural column is a continuous element comprising a first portion and a second portion, wherein the second portion may be angled relative to the first portion.

4. The vehicle of claim 1, wherein the second portion comprises an opening positioned below the seating assembly.

5. The vehicle of claim 3, wherein dimensions of a first end of the structural column located in the first portion are different than dimensions of a second end of the structural column located in the second portion.

6. The vehicle of claim 1, wherein the at least one other structural component is a keel beam positioned beneath the structural column.

7. The vehicle of claim 1, wherein the structural column is further configured to at least partially deform to absorb at least a portion of the force load.

8. The vehicle of claim 1, further comprising a display screen positioned on a second surface of the structural column, wherein the second surface is located opposite the first surface.

9. The vehicle of claim 1, wherein the seating assembly comprises a control device configured to control movement of the vehicle.

10. An aircraft, comprising:
a load-bearing element attached to a first interior surface at a first end and attached to a second interior surface at a second end; and
a pilot seat that is coupled to the load-bearing element and is oriented in a first direction;
wherein the load-bearing element is configured to provide structural support against a force load experienced during operation of the aircraft.

11. The aircraft of claim 10, wherein the aircraft is an electric take-off and landing vehicle.

12. The aircraft of claim 10, wherein the pilot seat is attached to a rod that is fixed to a first surface of the load-bearing element.

13. The aircraft of claim 12, wherein a height of the pilot seat is adjustable along a length of the rod.

14. The aircraft of claim 10, wherein the pilot seat comprises an arm rest and a control device attached to the arm rest.

15. The aircraft of claim 10, further comprising a display screen, positioned on a second surface of the load-bearing element, which is configured to present media content selected from the group consisting of: flight status information, entertainment media, and alert notifications.

16. The aircraft of claim 10, further comprising one or more passenger seats positioned in an area behind the pilot seat.

17. The aircraft of claim 10, wherein the one or more passenger seats are each oriented toward the first direction.

18. A method of redistributing a force load experienced by a vehicle, the method comprising:
receiving, at a support column positioned within a cabin of the vehicle, the force load, wherein the support column is positioned between a first and second interior surface of the vehicle; and
redistributing, via connection of the support column with an additional support element, the force load to the additional support element.

19. The method of claim 18, wherein the support column comprises a seating assembly attached to a first surface of the support column.

20. The method of claim 18, wherein the additional support element is a keel beam.
